(19) United States
(12) Patent Application Publication
(10) Pub. No.: US 2015/0092300 A1
(43) Pub. Date: Apr. 2, 2015

(54) ROTARY DEVICE

(71) Applicant: Samsung Electro-Mechanics Japan Advanced Co., Ltd., Shizuoka (JP)

(72) Inventor: Yoshio KUROKAWA, Shizuoka (JP)

(21) Appl. No.: 14/497,798

(22) Filed: Sep. 26, 2014

(30) Foreign Application Priority Data
Sep. 30, 2013 (JP) 2013-203211

(51) Int. Cl. G11B 19/20

(52) U.S. Cl. CPC G11B 19/2045
USPC 360/99.12

(57) ABSTRACT

A rotary device includes a rotatable member having an annular recess and a stationary member rotatably supporting the rotatable member. A circular cap having an outer circumferential edge is fixed to the rotatable member so as to cover an opening of a gap between the rotatable member and the stationary member. A receiving section, which has a shape to receive an adhesive on an outer peripheral portion of the cap, includes a diameter reduction part on the outer circumferential edge. The diameter reduction part has a smaller outer diameter than a maximum outer diameter of the outer circumferential edge. The thickness of the diameter reduction part is larger than or equal to a half of an entire thickness of the outer circumferential edge. An adhesive is applied to the diameter reduction part and the inner peripheral portion.

### CROSS-REFERENCE TO RELATED APPLICATIONS

This application is based upon and claims the benefit of priority of Japanese Patent Application No. 2013-203211 filed on Sep. 30, 2013, the entire contents of which are incorporated herein by reference.

### BACKGROUND OF THE INVENTION

1. Field of the Invention

The present invention generally relates to a rotary device.

2. Description of the Related Art

A dynamic pressure fluid bearing is used in a disk drive device such as, for example, a hard disk drive unit, which is one of the types of rotary devices. The dynamic pressure fluid bearing provided in the disk drive device includes a rotating member, a stationary member and a lubricant filled in a gap between the rotating member and the stationary member so as to rotatably support a recording disk. In the disk drive device equipped with the dynamic pressure fluid bearing having the above-mentioned structure, an operation failure may occur if the lubricant scatters and adheres to a recording disk surface while the recording disk is rotated. Thus, in order to prevent the lubricant from scattering, a cap is provided on the dynamic pressure fluid bearing to cover the gap between the rotating member and the stationary member in which the lubricant is filled. Such a structure of having a cap is disclosed in the following patent documents.

1) Japanese Laid-Open Patent Application No. 2009-136143

2) Japanese Laid-Open Patent Application No. 2010-286071

3) Japanese Laid-Open Patent Application No. 2011-2024

The above-mentioned cap has, for example, a disk-like shape, and is fitted into an annular groove provided in the rotatable member. The cap is fixed to the rotating member with an adhesive or the like.

However, if a bonding strength between the cap and the rotating member is weak, the cap may be displaced from an original attached position due to a vibration or shock during operation of the disk drive device. As a result, the scattering of lubricant cannot be prevented by the cap, which may cause an occurrence of operation failure.

### SUMMARY OF THE INVENTION

The present invention may provide a rotary device that substantially obviates one or more of the problems caused by the limitations and disadvantages of the related art.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by a rotary device particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides a rotary device including a rotatable member configured to be mounted with a recording disk and having an annular recess formed on a surface thereof, the annular recess having a bottom and an inner peripheral portion surrounding the bottom, a stationary member rotatably supporting the rotatable member via a dynamic pressure fluid bearing mechanism, a circular cap having an outer circumferential edge, the cap being fixed to the rotatable member so as to cover an opening of a gap between the rotatable member and the stationary member, and a receiving section having a shape to receive an adhesive on an outer peripheral portion of the cap. The receiving section includes a diameter reduction part on the outer circumferential edge, the diameter reduction part having a smaller outer diameter than a maximum outer diameter of the outer circumferential edge, a thickness of the diameter reduction part being larger than or equal to a half of an entire thickness of the outer circumferential edge, and an adhesive is applied to the diameter reduction part and the inner peripheral portion.

There is provided according to another embodiment a rotary device including a rotatable member configured to be mounted with a recording disk and having an annular recess formed on a surface thereof, the annular recess having a bottom and an inner peripheral portion surrounding the bottom, a stationary member rotatably supporting the rotatable member via a dynamic pressure fluid bearing mechanism, a circular cap having an outer circumferential edge, the cap being fixed to the rotatable member so as to cover an opening of a gap between the rotatable member and the stationary member, and a receiving section having a shape to receive an adhesive on an outer peripheral portion of the cap. The receiving section includes a diameter reduction part on the outer circumferential edge, the diameter reduction part having a smaller outer diameter than a maximum outer diameter of the outer circumferential edge, a thickness of the diameter reduction part being larger than or equal to a half of an entire thickness of the outer circumferential edge, and an adhesive is applied to the diameter reduction part and the inner peripheral portion.

There is provided according to a further embodiment a rotary device including a rotatable member configured to be mounted with a recording disk and having an annular recess formed on a surface thereof, the annular recess having a bottom and an inner peripheral portion surrounding the bottom, a stationary member rotatably supporting the rotatable member via a dynamic pressure fluid bearing mechanism, an annular cap having an outer circumferential edge, the cap being fixed to the rotatable member so as to cover an opening of a gap between the rotatable member and the stationary member, and a receiving section having a shape to receive an adhesive on an outer peripheral portion of the cap. The rotatable member has an annular groove in the bottom, a depth of the annular groove being gradually increased in a radial direction toward the inner peripheral portion. The receiving section includes a first bent part extending in a radial direction along an inner surface of the annular groove, and an adhesive is applied to the first bet part, the annular groove and the inner peripheral portion.

Other objects and features of the present invention will be apparent from the following detailed description when read in conjunction with the accompanying drawings.

### BRIEF DESCRIPTION OF THE DRAWINGS

FIGS. 1A-1C are schematic diagrams illustrating a rotary device according to a first embodiment;

FIG. 2 is a cross-sectional view of a part of the rotary device according to the first embodiment;

FIG. 3 is an enlarged cross-sectional view of a cap and a surrounding area of the cap according to the first embodiment;

FIG. 4 is an enlarged cross-sectional view of a cap and a surrounding area of the cap according to a second embodiment;

FIG. 5 is a perspective view of the cap according to the second embodiment;

FIG. 6 is an enlarged cross-sectional view of a cap and a surrounding area of the cap according to a third embodiment;

FIG. 7 is an enlarged cross-sectional view of a cap and a surrounding area of the cap according to a fourth embodiment; and

FIG. 8 is an enlarged cross-sectional view of a cap and a surrounding area of the cap according to a fifth embodiment.

### DESCRIPTION OF EMBODIMENTS

In the following, embodiments of the present invention will be described with reference to the accompanying drawings. Throughout the drawings, equivalent components/parts are denoted with the same reference numerals and a detailed explanation may be omitted where appropriate. In the detailed description of the embodiments of the present invention, the sizes of constituent elements may be enlarged or reduced in the drawings for aiding understanding of the embodiments of the present invention. Some of the components/parts in the drawings may be omitted for the sake of convenience in the explanation of embodiments.

Each of rotary devices according to the embodiments described below is capable of rotating, for example, a magnetic recording disk on which data can be recorded magnetically, and may be used as a hard disk drive unit.

### First Embodiment

<Configuration of Disk Drive Device>

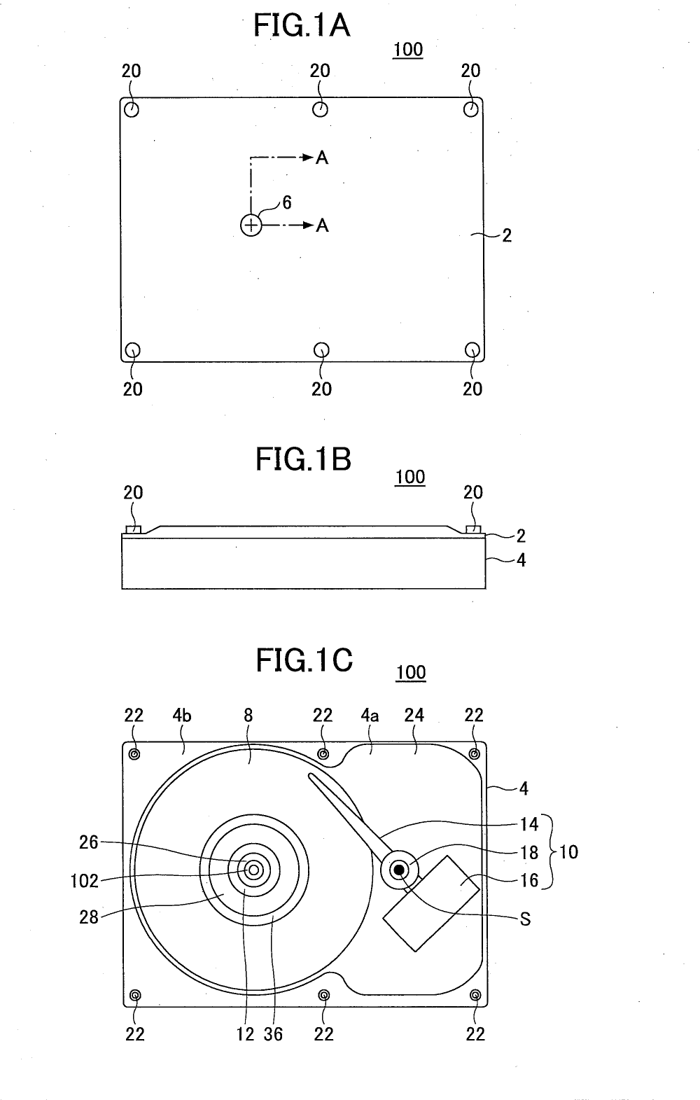

FIGS. 1A-1C illustrate a rotary device 100 according to a first embodiment of the present invention. FIG. 1A is a plan view of the rotary device 100. FIG. 1B is a side view of the rotary device 100. FIG. 10 is a plan view of the rotary device 100 where a top cover 2 is removed.

The rotary device 100 includes the top cover 2, a base 4, a magnetic recording disk 8, a data read/write part 10, a cap 12, a shaft 26, a hub 28, a clamper 36 and a housing 102.

A description is given below on the assumption that, in a state where the top cover 2 is attached to the base 4, the side where the top cover 2 is located is an upper side and the side where the base 4 is located is a lower side. A direction parallel to the rotating direction of the magnetic recording disk 8 is referred to as an axial direction. An arbitrary direction passing through the axial direction and parallel to a plane perpendicular to the axial direction is referred to as a radial direction. A farther side from the rotating axis in a radial direction is referred to as an outer periphery side, and a closer side to the rotating axis is referred to as an inner periphery side. These notations or definitions do not limit a position of the rotary device 100 when it is used, and the rotary device 100 may be used in an arbitrary position.

(Top Cover)

The top cover 2 can be formed by pressing, for example, an aluminum plate or a steel plate. The top cover 2 may be applied with a surface treatment such as plating in order to prevent corrosion.

The top cover 2 is fixed onto a top surface of the base 4 with peripheral screws 20. The top cover 2 and the base 4 are tightly fixed to each other to hermetically seal an interior space formed by the top cover 2 and the base 4. A fixing screw 6 is inserted into an opening formed at the center of the top cover 2, and is connected with a fixing screw hole formed in a housing 102 that is fixed to the base 4.

(Base)

As illustrated in FIG. 10, the base 4 includes a bottom plate 4a that forms a bottom part of the rotary device 100 and an outer peripheral wall 4b that is formed along the outer periphery of the base plate 4a in a manner surrounding an area for mounting the magnetic recording disk 8. Screw holes 22 are provided on the top surface of the outer peripheral wall 4b of the base 4 so that the peripheral screws 20 can be screwed into the screw holes 22.

The top cover 2 is fixed onto the top surface of the outer peripheral wall 4b of the base 4 by the peripheral screws 20 being screwed into the screw holes 22. A disk accommodating space 24 is formed by being surrounded by the bottom plate 4a and the outer peripheral wall 4b of the base 4 and the top cover 2. The disk accommodating space 24 is isolated from an external environment. The disk accommodating space 24 is filled with clean air containing a less amount of dusts or the like. Accordingly, the magnetic recording disk 8 is suppressed from being adhered with foreign particles, thereby reducing a possibility of failure occurring in an operation of the rotary device 100.

The base 4 can be formed by, for example, performing a die cast process using an aluminum alloy. The base 4 may be formed by performing a pressing process using a metal plate such as an aluminum plate or a stainless steel plate. In the case of using a pressing process, an emboss process may be applied in which convex parts are formed on an upper side of the base 4. By applying the emboss process to a predetermined part of the base 4, the base 4 can be prevented from deforming.

The base 4 may include a plating layer formed of a metal material such as, for example, nickel, chrome, etc., or a coating layer formed of a resin material such as epoxy resin. According to such a surface treatment layer, the base 4 is prevented from having surface peeling. Moreover, if the magnetic recording disk 8 is brought into contact with a surface of the base 4 during a manufacturing process of the rotary device 100, a possibility of damage in the surface of the base 4 and the magnetic recording disk 8 is reduced. Further, the plating layer can provide a smaller coefficient of friction and a higher surface hardness of the base 4 than that of the coating layer of a resin material, thereby further reducing the possibility of damage on the surface of the base 4 and the magnetic recording disk 8 due to a contact.

(Data Read/Write Part)

The data read/write part 10 includes a recording/reproducing head (not illustrated in the figures), a swing arm 14, a voice coil motor 16 and a pivot assembly 18. The recording/reproducing head is attached to an end of the swing arm 14. The recording/reproducing head records data on the magnetic recording disk 8, and reads data from the magnetic recording disk 8. The pivot assembly 18 swingably supports the swing arm 14 about a head rotation axis S. The recording/reproducing head is moved to a desired position above the magnetic recording disk 8 by driving the swing arm 14 by activating the voice coil 16. The voice coil motor 16 and the pivot assembly 18 can be constituted according to a known technique to control a head position.

(Magnetic Recording Disk)

The magnetic recording disk 8 is, for example, a 2.5 inch type magnetic recording disk that is formed of glass. The magnetic recording disk 8 has a diameter of 65 mm and a thickness of 0.65 mm. A center hole that is fitted to the hub 28 has a diameter of 20 mm. In the rotary device 100 according to the present embodiment, one piece of the magnetic recording disks 8 is mounted to an outer periphery of the hub 28.

<Configuration of Bearing Mechanism>

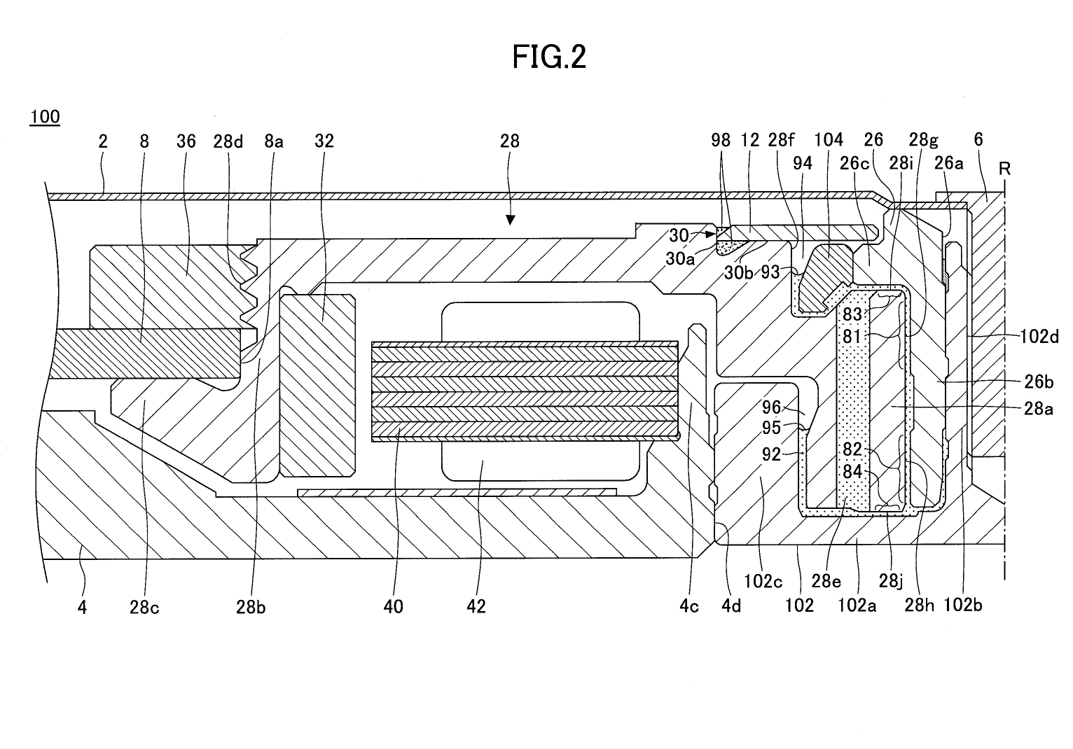

FIG. 2 is a cross-sectional view of the rotary device 100 taken along a line A-A of FIG. 1A. FIG. 2 illustrates a configuration of a dynamic pressure fluid bearing mechanism of the rotary device 100 according to the present embodiment.

The rotary device 100 includes, as a stationary part or member, the base 4, the shaft 26, a stator core 40, a coil 42, the housing 102 and a ring member 104. Additionally, the rotary device 100 includes, as a rotatable part or member, the cap 12, the hub 28, a cylindrical magnet 32 and a clamper 36.

In the rotary device 100, a lubricant 92 is filled in a gap between the hub 28 and each of the shaft 26, the housing 102 and the ring member 104. The rotatable member including the hub 28 to which the magnetic recording disk 8 is mounted is rotatably supported by the stationary member.

(Hub)

The hub 28 can be formed by, for example, performing a machining process or a pressing process on a steel material such as, for example, a stainless steel having a soft magnetic property. A surface treatment such as, for example, electroless nickel plating may be applied to the surface of the hub 28 in order to suppress peeling of minute residues adhering on the processed surface of the hub 28. Although the hub 28 according to the present embodiment is formed into a single piece member, the hub 28 may be formed by a plurality of members combined into a single piece.

The hub 28 includes a shaft surrounding part 28a surrounding the shaft 26, a cylindrical part 28b fitting into a center hole 8a of the magnetic disk 8, and a placement part 28c on which the magnetic recording disk 8 is placed. Additionally, the hub 28 includes a threaded part 28d formed on an outer peripheral surface of the cylindrical part 28b with which the clamper 36 engages. The hub 28 further includes a communication path 28e, which extends between a top surface and a bottom surface of the shaft surrounding part 28a, to communicate the upper side of the top surface of the shaft surrounding part 28a with the lower side of the bottom surface of the shaft surrounding part 28a. The communication path 28e is provided to reduce a difference in pressure applied to the lubricant 92 in an area where the lubricant 92 is filled in the above-mentioned gap between the hub 28 and each of the shaft 26, the housing 102 and the ring member 104 in order to stabilize the rotation of the hub 28.

The center hole 8a of the magnetic recording disk 8 fits in the cylindrical part 28b of the hub 28, and the magnetic recording disk 8 is fixed to the hub 28 by being clamped by the clamper 36 and the placement part 28c. Accordingly, the magnetic recording disk 8 rotates together with the hub 28.

(Clamper)

The clamper 36 is formed into a disk-like shape having a center hole. The clamper 36 can be formed by cutting a steel material such as, for example, a stainless steel. The clamper 36 is fixed to the hub 28 by being engaged with the threaded part 28d formed on the outer peripheral surface of the cylindrical part 28b of the hub 28. The clamper 36 presses the magnetic recording disk 8 against the placement part 28c of the hub 28 in order to fix the magnetic recording disk 8 to the hub 28.

(Cylindrical Magnet)

The cylindrical magnet 32 is fixed to the inner peripheral surface of the cylindrical part 28b of the hub 28 by an adhesive. The cylindrical magnet 32 is formed of, for example, a ferrite magnetic material or a rare earth magnetic material that contains a resin material such as polyamide as a binder. The cylindrical magnet 32 may be formed of, for example, a lamination of a ferrite magnet layer and a rare earth magnet layer.

The cylindrical magnet 32 is provided with, for example, twelve magnetic poles arranged in a circumferential direction of the inner peripheral surface thereof. The inner peripheral surface of the cylindrical magnet 32 opposes to the outer peripheral surface of the stator core 40 in a radial direction so that salient poles formed by the stator core 40 face the magnetic poles of the cylindrical magnet 32 with a predetermined gap therebetween.

(Stator Core)

The stator core 40 includes a circular ring part and nine pieces of the salient poles extending toward the outer peripheral side from the circular ring part. The stator core 40 is fixed to the outer peripheral surface of a protruding part 4c, which cylindrically protrudes from a bottom surface of the base 4, by press fitting or loose fitting. The stator core 40 is formed by laminating, for example, six thin electromagnetic steel sheets each having a thickness of 0.2 mm into one piece by caulking. Insulation painting or coating such as, for example, electrodeposition coating or powder coating is applied onto the surface of the stator core 40. A coil 42 is formed by winding conductive wire such as copper wire or the like on each of the salient poles of the stator core 40. A drive magnetic flux is generated along each of the salient poles by causing an electric current flowing through the coil 42.

(Housing)

The housing 102 is fixed to the base 4, and rotatably supports the hub 28 in cooperation with the shaft 26 that is fixed to and supported by the housing 102. The housing 102 includes a flat and annular bottom part 102a, a protruding part 102b and a cylindrical part 102c. The protruding part 102b protrudes upward from the inner periphery of the bottom part 102a. The cylindrical part 102c protrudes upward from the outer periphery of the bottom part 102a, and surrounds the lower end of the shaft surrounding part 28a of the hub 29.

The housing 102 is fixed to the base 4 by the cylindrical part 102 being press fitted in or bonded to a center hole 4d provided in the inner periphery of the protruding part 4c of the base 4. The center of the center hole 4d coincides with the rotation axis R.

The protruding part 102b is provided with a fixing screw hole 102d into which a fixing screw 6 is inserted from an upper end of the protruding part 102 along the axial direction. The top cover 2 is fixed by the fixing screw 6 being engaged with the fixing screw hole 102d.

(Shaft)

The shaft 26 includes a support hole 26a having a center that coincides with the rotation axis R. The shaft 26 is fixed to and supported by the protruding part 102b of the housing 102 being inserted into the support hole 26a. The shaft 26 includes a cylindrical part 26b and a flange part 26c. The cylindrical part 26b surrounds the protruding part 102b of the housing 102. The flange part 26c protrudes annularly and radially outward from the upper end of the cylindrical part 26b.

The ring member 104 having an annular shape is fixed to the outer peripheral surface of the flange part 26c by press fitting with an adhesive. The adhesive provided between the flange part 26c and the ring member 104 serves as a sealing material to prevent the lubricant 92 from leaking through a gap between the flange part 26c and the the rig member 104.

(Lubricant and Seal Structure)

The lubricant 92 is filled in the gap between the hub 28 and each of the shaft 26, the housing 102 and the ring member 104 and also filled in the communication path 28e of the hub 28. The lubricant 92 contains basic oil added with fluorescent material or phosphor so that, if the lubricant 92 leaks between the members, the leakage can be easily detected by irradiating a light having a predetermined wavelength to an area where the lubricant 92 may leak.

A first air/liquid interface 93 is formed between the ring member 104 and the inner peripheral surface 28f of the hub 28 facing the ring member 104 in a radial direction.

A tapered surface is formed in the outer peripheral surface of the ring member 104 so that a distance between the outer peripheral surface of the ring member 104 and the inner peripheral surface 28f of the hub 28 increases upwardly. According to such a structure, a first seal part 94 is formed between the side surface of the ring member 104 and the inner peripheral surface 28f of the hub 28. The first seal part 94 is a taper-shaped space having a radial width increasing upwardly. In the first seal part 94, a downward force is exerted on the lubricant 92 to move the lubricant 92 downward according to a capillary phenomenon. Thus, the lubricant 92 is confined in the space between the ring member 104 and the inner peripheral surface 28f of the hub 28.

Moreover, a second air/liquid interface 95 is formed between the lower end outer peripheral surface of the shaft surrounding part 28a of the hub 28 and the inner peripheral surface of the cylindrical part 102c of the housing 102.

A tapered surface is provided in the outer peripheral surface of the shaft surrounding part 28a of the hub 28 so that a distance between the outer peripheral surface of the shaft surrounding part 28a of the hub 28 and the inner peripheral surface of the cylindrical part 102c of the housing 102 increases upwardly. According to such a form, a second seal part 96 is formed between the outer peripheral surface of the shaft surrounding part 28a of the hub 28 and the inner peripheral surface of the cylindrical part 102c of the housing 102. The second seal part 96 is a space having a tapered shape in which a radial distance between the hub 28 and the housing 102 gradually increases upwardly. Accordingly, in the second seal part 96, a downward force is exerted on the lubricant 92 to move the lubricant 92 downward according to a capillary phenomenon. Thus, the lubricant 92 is confined in the space between the hub 28 and the housing 102.

(Dynamic Pressure Generating Part)

A first radial dynamic pressure generating part 81 and a second radial dynamic pressure generating part 82 are formed in an upper portion and a lower portion of a space, respectively, between the outer peripheral surface of the cylindrical part 26b of the shaft 26 and the inner peripheral surface of the shaft surrounding part 28a of the hub 28. The first radial dynamic pressure generating part 81 and the second radial dynamic pressure generating part 82 are separated in the axial direction.

A first radial dynamic pressure generating groove 28g having, for example, a herring bone shape or a spiral shape is provided in a portion of the inner peripheral surface of the shaft surrounding part 28a of the hub 28 facing the first radial dynamic pressure generating part 81. Additionally, a second radial dynamic pressure generating groove 28h having, for example, a herring bone shape or a spiral shape is provided in a portion of the inner peripheral surface of the shaft surrounding part 28a of the hub 28 facing the second radial dynamic pressure generating part 82. Either one or both of the first radial dynamic pressure groove 28g and the second radial dynamic pressure groove 28h may be provided in the outer peripheral surface of the cylindrical part 26b of the shaft 26.

A first thrust dynamic pressure generating part 83 is provided between the top surface of the shaft surrounding part 28a of the hub 28 and the bottom surface of the flange part 26c of the shaft 26. Additionally, a second thrust dynamic pressure generating part 84 is provided between the bottom surface of the shaft surrounding part 28a of the hub 28 and the top surface of the bottom part 102a of the housing 102.

A first thrust dynamic pressure generating groove 28i having, for example, a herring bone shape or a spiral shape is formed in a portion of the top surface of the shaft surrounding part 28a of the hub 28 facing the first thrust dynamic pressure generating part 83. Additionally, a second thrust dynamic pressure generating groove 28j having, for example, a herring bone shape or a spiral shape is formed in a portion of the bottom surface of the shaft surrounding part 28a of the hub 28 facing the second thrust dynamic pressure generating part 84. The first thrust dynamic pressure generating groove 28i may be provided in the bottom surface of the flange part 26c of the shaft 26. The second thrust dynamic pressure generating groove 28j may be provided in the top surface of the bottom part 102a of the housing 102.

When the hub 28 is rotated with respect to the shaft 26 and the housing 102, a dynamic pressure is generated in the lubricant 92 in each of the first radial dynamic pressure generating part 81, the second radial dynamic pressure generating part 82, the first thrust dynamic pressure generating part 83, and the second thrust dynamic pressure generating part 84. Accordingly, the hub 28 can be supported in the axial direction and the radial direction by the dynamic pressure generated in the lubricant 92 in a non-contacting state with the shaft 26 and the housing 102.

Each of the first radial dynamic pressure generating groove 28g, the second radial dynamic pressure generating groove 28h, the first thrust dynamic pressure generating groove 28i and the second thrust dynamic pressure generating groove 28j can be formed by, for example, pressing, ball roll forming, electro chemical machining or cutting by controlling a tool using a piezoelectric device. Each of these grooves may be formed by a different processing method.

(Cap)

The circular (annular disk-shaped) cap 12 is fixed to the hub 28 in order to cover the first air/liquid interface 93 formed between the inner peripheral surface 28f of the hub 28 and the ring member 10. The cap 12 prevents the lubricant 92 from scattering from the first air/liquid interface 93 to the interior of the device including the disk accommodation space 24.

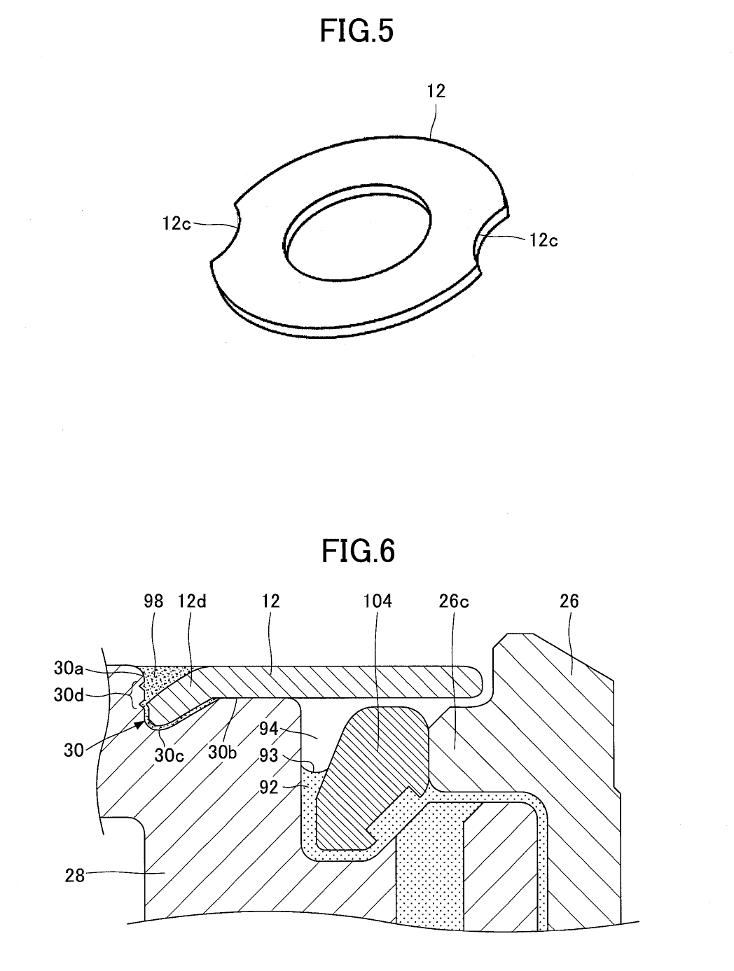

The cap 12 is provided in an annular step part 30 formed on a mounting surface of the hub 28 (the top surface side in FIG. 2) on which the magnetic recording disk 8 is mounted. The annular step 30 is an annular recess having a center which coincides with the rotation axis R. Hereinafter, the annular step part 30 may be referred to as the “annular recess 30”. The cap 12 fits in the inner peripheral surface 30a of the annular recess 30 of the hub 28. The cap 12 is placed on the bottom surface 30b of the annular recess 30 and fixed to the hub 28 by an adhesive 98. Although the cap 12 has an annular shape as illustrated, for example, in FIG. 5, the cap 12 may have a circular shape to cover an entire circular area defined by the inner peripheral surface 30a of the annular recess 30.

FIG. 3 is an enlarged cross-sectional view of a portion of the rotary device 100 including the cap 12 according to the present embodiment.

As illustrated in FIG. 3, the annular recess 30 of the hub 28 is provided with an annular groove 30c on the outer peripheral side of the bottom surface 30b. The depth of the annular groove 30c increases toward the inner peripheral surface 30a of the hub 28. The annular groove 30c serves as an adhesive pool which stores the adhesive 98 to fix the cap 12 to the hub 28.

As illustrated in FIG. 3, a diameter reduction surface 12b is provided on the outer side edge of the cap 12. The diameter reduction surface 12b inclines with respect to the axial direction so that an outer diameter of the cap 12 measured at any point on the diameter reduction surface 12b is smaller than a maximum diameter of a maximum diameter part 12a of the cap 12.

The cap 12 is placed on the bottom surface 30b of the annular recess 30. When viewed from above in a direction parallel to the rotation axis R, the bottom surface 30b is located inside a circle defining a boundary between the top surface of the cap 12 and the diameter reduction surface 12b of the cap 12.

The adhesive 98 is applied between the diameter reduction surface 12b of the cap 12 and the inner peripheral surface 30a of the annular recess 30 of the hub 28 in order to fix the cap 12 to the hub 28. The space formed between the diameter reduction surface 12b of the cap 12 and the inner peripheral surface 30a of the annular recess 30 serves an adhesive pool in which the adhesive 98 is stored. According to forming the space in which the adhesive 98 can be stored, a large amount of the adhesive 98 can be applied over the diameter reduction surface 12b and the inner peripheral surface 30a without the adhesive 98 being heaped up on the top surface of the cap 12. Thus, the cap 12 can be fixed to the hub 28 using a sufficient amount of adhesive 98, thereby increasing a bonding strength between the cap 12 and the hub 28. Thus, the diameter reduction surface 12b of the cap 12 serves as a receiving section that receives and retains a greater amount of the adhesive 98 so that the cap 12 is securely fixed to the hub 28.

A description is given below of a size of the diameter reduction surface 12b. If a width of the diameter reduction surface 12b in a radial direction is small, the adhesive 98 applied between the diameter reduction surface 12b and the inner peripheral surface 30a may move beyond the boundary between the diameter reduction surface 12b and the top surface of the cap 12, which results in the adhesive 98 riding on the top surface of the cap 12 and bulging upward. If such a situation occurs in which the adhesive 98 before being solidified goes over the top surface of the cap 12 during the manufacturing process of the rotary device 100, it is possible that the adhesive 98 before being solidified adheres onto components of a manufacturing tool. Thus, the manufacturing process requires a careful operation, and, thereby, the productivity may go down. This indicates that the possibility of the adhesive 98 riding on the top surface of the cap 12 becomes smaller as the width of the diameter reduction surface 12b in a radial direction is set larger, thereby improving work efficiency in the manufacturing process and, as a result, improving the productivity. Especially, if a thickness of a portion of the cap 12 corresponding to the diameter reduction surface 12b is smaller than or equal to a half (½) of the thickness of the cap 12, it is found that degradation in the productivity hardly occurs.

The cap 12 is formed by cutting or pressing, for example, a nonferrous metal or a steel material such as a stainless steel. The cap 12 may be formed by, for example, resin molding. Additionally, the cap may include, for example, a charcoal filter or a porous material such as a sintered material so as to catch a greater amount of the adhesive 98 scattering from the first air/liquid interface 93.

It should be noted that the diameter reduction surface 12b of the cap 12 may be formed in, for example, a step form. The shape of the diameter reduction surface 12b is not limited to that illustrated in FIG. 3 of the present embodiment, if such a shape can confine the adhesive 98 within a space below the top surface of the cap 12.

As mentioned above, according to the first embodiment, the cap 12 is bonded and fixed to the hub 28 by the adhesive 98 being applied to both sides of the cap 12, that is, the diameter reduction surface 12b (inclined surface) and the bottom surface of the cap 12. It is possible to use a greater amount of the adhesive 98 by providing the space between the inner peripheral surface 30a of the annular step part 30 and each of the inner surface of the annular groove 30c and the diameter reduction surface 12b of the cap 12 to serve as an adhesive pool, which increases the bonding strength between the cap 12 and the hub 28. Thus, even if the rotary device 100 receives a shock or vibration, the cap 12 is not displaced nor removed and the lubricant 92 is prevented from scattering into the interior of the rotary device 100 including the disk accommodating space 24, thereby improving the operation stability of the rotary device 100.

### Second Embodiment

A description is given of a second embodiment with reference to the drawings. In the following description, parts that are the same as the parts already explained in the above mentioned embodiment are given the same reference numerals, and duplicate descriptions will be omitted appropriately.

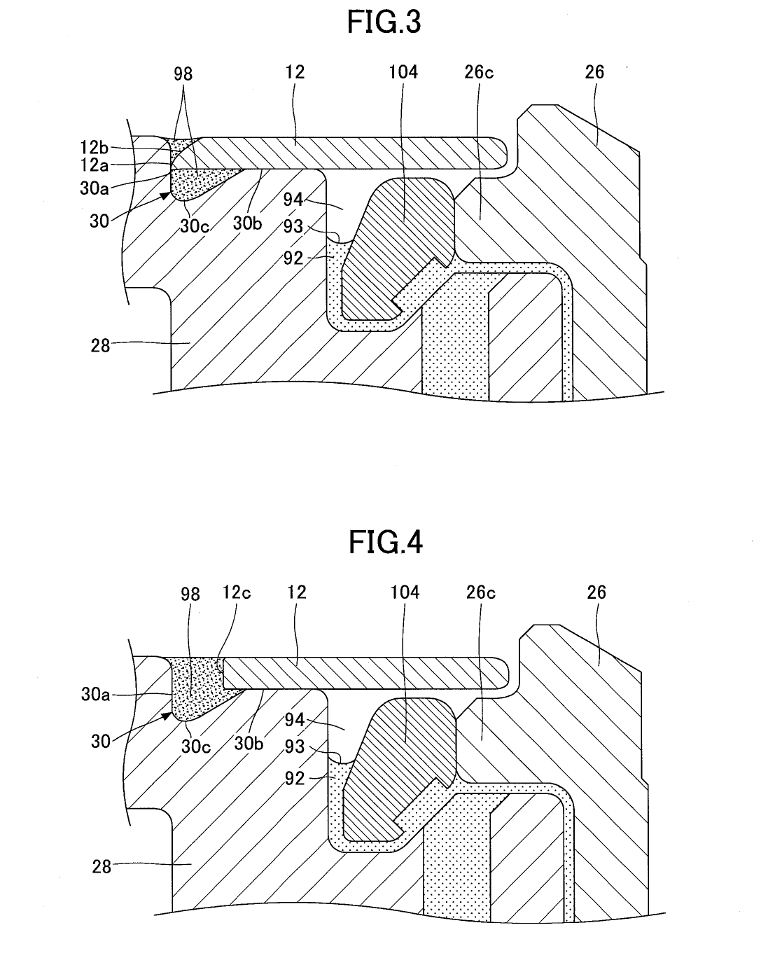

FIG. 4 is an enlarged cross-sectional view of the cap 12 and parts surrounding the cap 12 according to the second embodiment. FIG. 5 is a perspective view of the cap 12 according to the second embodiment.

As illustrated in FIG. 5, the cap 12 according to the second embodiment has two notched parts 12c formed in an outer circumferential edge part thereof, each of which is dented inwardly toward the center of the cap 12, which coincides with the rotation axis R.

The cap 12 is placed on the bottom surface 30b of the annular recess 30. When viewed from above in a direction parallel to the rotation axis R, the bottom surface 30b is located inside an area defined by a contour of the cap 12 having the notched parts 12c.

In an area of the cap 12 where each notched part 12c is provided, as illustrated in FIG. 4, a space for pooling the adhesive 98 is formed between the notched part 12c of the cap 12 and each of the inner peripheral surface 30a of the annular step part 30 and the inner surface of the annular groove 30c of the hub 28.

The cap 12 is bonded and fixed to the hub 28 by the adhesive 98 applied over the inner peripheral surface 30a of the annular recess 30 and the inner surface of the annular groove 30c. A sufficient amount of the adhesive 98 can be applied to the area provided with each notched part 12c, thereby increasing the bonding strength between the cap 12 and the hub 28. Thus, the notched part 12c of the cap 12 serves as a receiving section that receives and retains a greater amount of the adhesive 98 so that the cap 12 is securely fixed to the hub 28.

It should be noted that the notched part 12c is not limited to the circular arc shape as illustrated in FIG. 5, and may have a different shape such as, for example, a rectangular shape. Additionally, the notched part 12c may be formed at one or more positions in the outer circumferential edge part of the cap 12.

Moreover, similar to the first embodiment, the diameter reduction surface 12b may be provided on the outer circumferential edge surface of the cap 12 so that the diameter of the cap 12 is reduced at any point on the diameter reducing part 12. If the cap 12 has the diameter reduction surface 12b in the present embodiment, the adhesive 98 can be applied to both sides of the cap 12, thereby further increasing the bonding strength between the cap 12 and the hub 28.

As mentioned above, according to the second embodiment, a greater amount of the adhesive 98 can be applied to the space between each notched part 12c of the cap 12 and each of the inner surface of the annular groove 30c and the inner peripheral surface 30a of the annular step part 30 of the hub 28, thereby increasing the bonding strength between the cap 12 and the hub 28. Accordingly, even if the rotary device 100 receives a shock or vibration, the cap 12 is not displaced or removed and the lubricant 92 is prevented from scattering into the interior of the rotary device 100 including the disk accommodation space 24, thereby improving the operation stability of the rotary device 100.

### Third Embodiment

A description is given of a third embodiment with reference to the drawings. In the following description, parts that are the same as the parts already explained in the above mentioned embodiments are given the same reference numerals, and duplicate descriptions will be omitted appropriately.

FIG. 6 is an enlarged cross-sectional view of the cap 12 and parts surrounding the cap 12 according to the third embodiment.

As illustrated in FIG. 6, the cap 12 according to the third embodiment has a first bent part 12d that is an outer peripheral part bent downward to extend along the inner surface of the annular groove 30c of the annular recess 30. The first bent part 12d is bent obliquely downward. The cap 12 is bonded and fixed to the hub 28 by the adhesive applied over the first bent part 12d and the inner peripheral surface 30a of the annular recess 30. Thus, the first bent part 12d serves as a receiving section that receives and retains a greater amount of the adhesive 98 so that the cap 12 is securely fixed to the hub 28.

Moreover, provided in the inner surface 30a of the annular recess 30 are catching or engagement grooves 30d that are brought into engagement with the first bent part 12d. That is, an outer circumferential edge of the first bent part 12d enters the engagement grooves 30. The cap 12 is prevented from being displaced or removed from the hub 28 by the engagement grooves 30d in addition to the adhesive 98. The adhesive 98 is also filled in the engagement grooves 30d, thereby increasing the bonding strength between the cap 12 and the hub 28. Thus, each engagement groove 30d serves as a receiving section that receives and retains a greater amount of the adhesive 98 so that the cap 12 is securely fixed to the hub 28.

It should be noted that, similar to the second embodiment, one or more notched parts 12c may be provided in the outer circumferential edge part of the cap 12. An adhesive pool is formed by the adhesive 98 being applied to a portion where each notched part 12c is formed, thereby further increasing the bonding strength between the cap 12 and the hub 28.

As mentioned above, according to the third embodiment, the cap 12 is bonded and fixed to the hub 28 by the adhesive 98 applied to the top surface of the first bent part 12d. Accordingly, the cap 12 can be fixed from the side of the top surface of the cap 12 to the hub 28 without causing the adhesive 98 to overflow onto the top surface of the cap 12, which permits an increase in the bonding strength between the cap 12 and hub 28. Additionally, the cap 12 is prevented from being displaced or removed from the hub 28 by the first bent part 12d being engaged with the engagement grooves 30d provided in the inner peripheral surface 30a of the annular step part 30, thereby preventing the cap 12 from being displaced or removed from the hub 28, and, as a result, improving the operation stability of the rotary device 100.

### Fourth Embodiment

A description is given of a fourth embodiment with reference to the drawings. In the following description, parts that are the same as the parts already explained in the above mentioned embodiments are given the same reference numerals, and duplicate descriptions will be omitted appropriately.

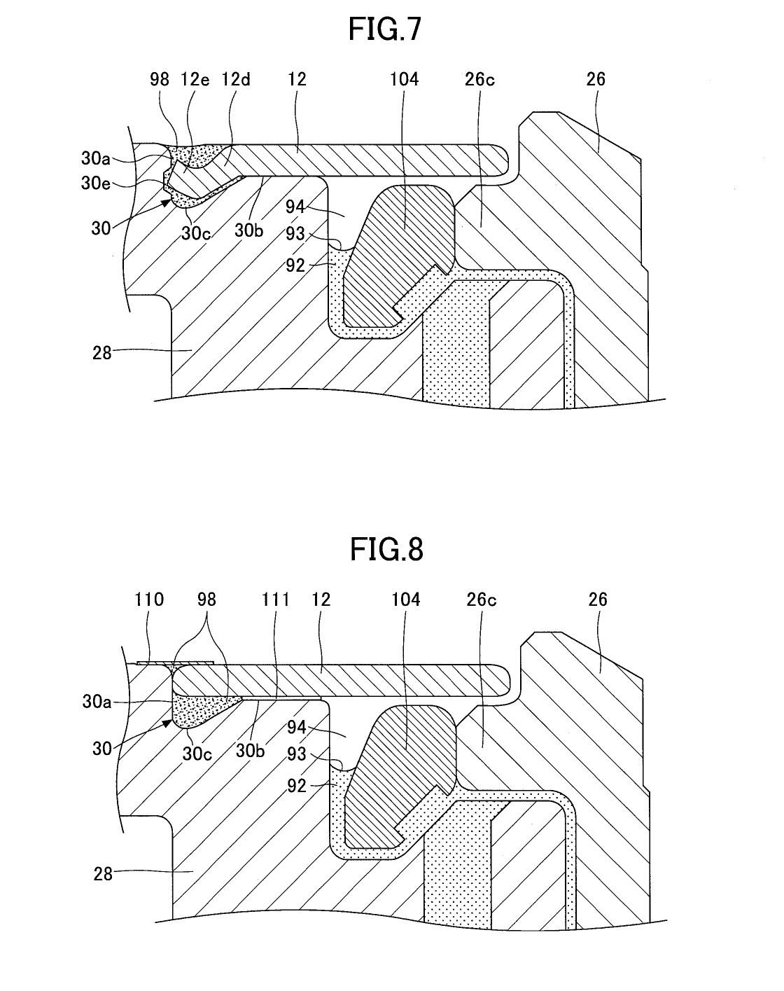

FIG. 7 is an enlarged cross-sectional view of the cap 12 and parts surrounding the cap 12 according to the fourth embodiment.

As illustrated in FIG. 7, the cap 12 according to the fourth embodiment has a first bent part 12d that is an outer peripheral part being bent downward to extend along the inner surface of the annular groove 30c of the annular recess 30. The cap 12 further has a second bent part 12e that is an outer peripheral part of the first bent part being bent upwardly toward the inner peripheral surface 30a of the annular recess 30. Especially, the second bent part 12e extends in an obliquely upward direction different from the direction of the bend of the first bent part 12d. The cap 12 is fixed to the hub 28 by the adhesive 98 applied over the first and second bent parts 12d and 12e and the inner peripheral surface 30a of the annular recess 30.

Moreover, provided in the inner surface 30a of the annular step part 30 is an accommodating or engagement groove 30e that is brought into engagement with the second bent part 12d of the cap 12. Especially, the engagement groove 30e is formed in an annular shape so that the outermost peripheral part of the second bent part 12e of the cap 12 can enter the engagement groove 30e. The cap 12 is prevented from being displaced or removed from the hub 28 by the outer circumferential edge of the second bent part 12e entering or being engaged with the engagement groove 30e in addition to bonding by adhesive 98.

It should be noted that, similar to the second embodiment, one or more notched parts 12c may be provided in the outer circumferential edge part of the cap 12. An adhesive pool is formed by the adhesive 98 being applied to a portion where each notched part 12c is formed, thereby further increasing the bonding strength between the cap 12 and the hub 28.

As mentioned above, according to the fourth embodiment, the cap 12 is bonded and fixed to the hub 28 by the adhesive 98 applied to the top surfaces of the first and second bent parts 12d and 12e. Accordingly, the cap 12 can be fixed from the side of the top surface of the cap 12 to the hub 28 without causing the adhesive 98 to overflow onto the top surface of the cap 12, which permits an increase in the bonding strength between the cap 12 and hub 28. Additionally, the cap 12 is prevented from being displaced or removed from the hub 28 by the second bent part 12e being engaged with the engagement groove 30e provided in the inner peripheral surface 30a of the annular step part 30, thereby preventing the cap 12 from being displaced or removed from the hub 28 and, as a result, improving the operation stability of the rotary device 100.

### Fifth Embodiment

A description is given of a fifth embodiment with reference to the drawings. In the following description, parts that are the same as the parts already explained in the above mentioned embodiments are given the same reference numerals, and duplicate descriptions will be omitted appropriately.

FIG. 8 is an enlarged cross-sectional view of the cap 12 and parts surrounding the cap 12 according to the fifth embodiment.

As illustrated in FIG. 8, the cap according to the fifth embodiment is fixed to the annular recess 30 of the hub 28 by an adhesive sheet 110 and a double-sided adhesive sheet 111 in addition to bonding by the adhesive 98. The cap 12 may be fixed to the hub 28 by either one of the adhesive sheet and the double-sided adhesive sheet 111 without using the adhesive 98.

The adhesive sheet 110 is applied over the top surface of the hub 28 and the top surface of the cap 12 to fix the cap 12 to the hub 28 from the top side. The double-sided adhesive sheet 11 is applied between the reverse face of the cap 12 and the bottom surface 30a of the annular recess 30 of the hub 28h to fix the cap 12 to the hub 28 from the reverse side. Each of the adhesive sheet 110 and the double-sided adhesive sheet 111 may be applied over an entire peripheral area of the cap 12, or may be applied portions arranged along the peripheral area of the cap 12. Both the adhesive sheet 110 and the double-sided adhesive sheet 111 are not necessarily used to fix the cap 12, and only one of the adhesive sheet 110 and the double-sided adhesive sheet 111 may be used to fix the cap 12.

The cap 12 is prevented from being displaced or removed from the hub 28 by being fixed by the adhesive sheet 110 and the double-sided adhesive sheet 111. The cap 12 is further prevented from being displaced or removed from hub 28 by being fixed to the hub by the adhesive 98 in addition to the adhesive sheet 110 and the double-sided adhesive sheet 111.

It should be noted that, similar to the first embodiment, the diameter reduction surface 12b may be provided on the outer circumferential edge surface of the cap 12 so that the diameter of the top surface of the cap 12 is reduced. If the cap 12 has the diameter reduction surface 12b in the present embodiment, the adhesive 98 can be applied to both sides of the cap 12, thereby further increasing the bonding strength between the cap 12 and the hub 28.

Moreover, similar to the second embodiment, one or more notched parts 12c may be provided on the outer peripheral edge of the cap 12. An adhesive pool is formed by the adhesive 98 being applied to a portion where each notched part 12c is formed, thereby further increasing the bonding strength between the cap 12 and the hub 28.

Furthermore, similar to the third embodiment, the first bent part 12d may be provided to the cap 12 by bending the outer peripheral part of the cap 12 to extend along the inner surface of the annular groove 30c of the annular step part 30. In such as case, the engagement grooves 30d may be provided in the inner peripheral surface 30a of the annular recess 30. Further, similar to the fourth embodiment, the second bent part 12e may be provided to the cap 12 by bending an outer peripheral part of the first bent port 12d to extend toward the inner peripheral surface 30a of the annular step part 30. In such a case, the engagement groove 30e may be provide in the inner peripheral surface of the annular step part 30a. According to the above-mentioned structure, the bonding strength between the cap 12 and the hub 28 can be further increased.

As mentioned above, according to the fifth embodiment, the cap 12 is fixed to the hub 28 by the adhesive 111 and the double-sided adhesive sheet 111. The bonding strength between the cap 12 and the hub 28 is increased by the adhesive 111 and the double-sided adhesive sheet 111, thereby preventing the cap 12 from being displaced or removed from the hub 28 and, as a result, improving the operation stability of the rotary device 100.

In the above-mentioned embodiments, the tapered space of each of the first seal part 94 and the second seal part 96 has a radial width gradually increasing toward the upper side thereof. However the tapered space is not limited to such a configuration. For example, the gap forming the tapered space of the first seal part 94 may be bent so that the opening of the tapered space is directed toward the rotation axis R, and the tapered space may be configured to have a width in the axial direction gradually increasing toward the rotation axis R.

Moreover, although the adhesive 98 is applied to a space lower than the cap 12 in the first to fourth embodiments, the position to which the adhesive 98 is applied is not limited to the space lower than the cap 12. For example, the adhesive 98 may be applied over the top surface of the cap 12 and the inner peripheral surface 30a of the annular step part 30.

The present invention is not limited to the specifically disclosed embodiments directed to the rotary device, and variations and modifications may be made without departing from the scope of the present invention.

What is claimed is

1. A rotary device, comprising:
a rotatable member configured to be mounted with a recording disk and having an annular recess formed on a surface thereof, the annular recess having a bottom and an inner peripheral portion surrounding the bottom;
a stationary member rotatably supporting the rotatable member via a dynamic pressure fluid bearing mechanism;
a circular cap having an outer circumferential edge, the cap being fixed to the rotatable member so as to cover an opening of a gap between the rotatable member and the stationary member; and
a receiving section having a shape to receive an adhesive on an outer peripheral portion of the cap,
wherein the receiving section includes a diameter reduction part on the outer circumferential edge, the diameter reduction part having a smaller outer diameter than a maximum outer diameter of the outer circumferential edge, a thickness of the diameter reduction part being larger than or equal to a half of an entire thickness of the outer circumferential edge, and an adhesive is applied to the diameter reduction part and the inner peripheral portion.

2. The rotary device as claimed in claim 1, wherein the cap has a notched part formed on the outer circumferential edge, the notched part being dented radially, and the adhesive is continuously applied to the diameter reduction part, the notched part and the inner peripheral portion.

3. The rotary device as claimed in claim 1, wherein the rotatable member has a seat formed in the bottom so that the cap is seated on the seat by being surrounded by the inner peripheral portion, and an axially recessed annular groove is formed in the bottom so that the annular groove surrounds the seat and is surrounded by the inner peripheral portion.

4. The rotary device as claimed in claim 3, wherein the cap has a bent part that is bent at a radial position outside an area corresponding to the seat, and the adhesive is continuously applied to the diameter reduction part, the bent part and the inner peripheral portion.

5. The rotary device as claimed in claim 4, wherein a depth of the annular groove being gradually increased in a radial direction toward the inner peripheral portion.

6. The rotary device as claimed in claim 1, wherein the rotatable member has a catching groove formed in the inner peripheral portion so that a part of the diameter reduction part enters the catching groove, and the adhesive is continuously applied to the catching groove, the diameter reduction part and the inner peripheral portion.

7. The rotary device as claimed in claim 1, further comprising an adhesive sheet applied from an end surface of the rotatable member to a top surface of the cap beyond the diameter reduction portion.

8. The rotary device as claimed in claim 1, further comprising a double-sided adhesive sheet applied between a bottom surface of the cap and the bottom.

9. A rotary device, comprising:
a rotatable member configured to be mounted with a recording disk and having an annular recess formed on a surface thereof, the annular recess having a bottom and an inner peripheral portion surrounding the bottom;
a stationary member rotatably supporting the rotatable member via a dynamic pressure fluid bearing mechanism; and
a circular cap having an outer circumferential edge, the cap being fixed to the rotatable member so as to cover an opening of a gap between the rotatable member and the stationary member; and
a receiving section having a shape to receive an adhesive on an outer peripheral portion of the cap,
wherein the receiving section includes a notched part formed on the outer circumferential edge, the notched part being dented radially, and an adhesive is applied to the notched part of the cap and the inner peripheral portion.

10. The rotary device as claimed in claim 9, wherein the rotatable member has a seat formed in the bottom so that the cap is seated on the seat by being surrounded by the inner peripheral portion, and an axially recessed annular groove is formed in the bottom so that the groove surrounds the seat and is surrounded by the inner peripheral portion.

11. The rotary device as claimed in claim 10, wherein the cap has a bent part that is bent at a radial position outside an area defined by the seat, and the adhesive is continuously applied to the notched part, the bent part and the inner peripheral portion.

12. The rotary device as claimed in claim 11, wherein a depth of the annular groove being gradually increased in a radial direction toward the inner peripheral portion.

13. The rotary device as claimed in claim 9, wherein the rotatable member has an engagement groove formed in the inner peripheral portion so that the outer circumferential edge is brought into contact with the engagement groove, and the adhesive is continuously applied to the engagement groove, the notched part and the inner peripheral portion.

14. The rotary device as claimed in claim 9, further comprising an adhesive sheet applied from the rotatable member to a top surface of the cap beyond the notched part.

15. The rotary device as claimed in claim 9, further comprising a double-sided adhesive sheet applied between an end surface of the cap and the bottom.

16. A rotary device, comprising:
a rotatable member configured to be mounted with a recording disk and having an annular recess formed on a surface thereof, the annular recess having a bottom and an inner peripheral portion surrounding the bottom;
a stationary member rotatably supporting the rotatable member via a dynamic pressure fluid bearing mechanism;
an annular cap having an outer circumferential edge, the cap being fixed to the rotatable member so as to cover an opening of a gap between the rotatable member and the stationary member; and
a receiving section having a shape to receive an adhesive on an outer peripheral portion of the cap,
wherein the rotatable member has an annular groove in the bottom, a depth of the annular groove being gradually increased in a radial direction toward the inner peripheral portion, and
wherein the receiving section includes a first bent part extending in a radial direction along an inner surface of the annular groove, and an adhesive is applied to the first bet part, the annular groove and the inner peripheral portion.

17. The rotary device as claimed in claim 16, wherein the rotatable member has an accommodating groove formed in the inner peripheral portion so that an outer circumferential edge of the first bent part enters the accommodating groove, and the adhesive is continuously applied to the accommodating groove and the first bent part.

18. The rotary device as claimed in claim 16, wherein
the cap has a second bent part in an outer circumferential part of the first bent part, and
the rotatable member has an accommodating groove formed in the inner peripheral portion so that an outer circumferential edge of the second bent part enters the accommodating groove, and the adhesive is continuously applied to the accommodating groove and the second bent part.

19. The rotary device as claimed in claim 16, wherein the cap has a notched part formed in the outer circumferential edge, the notched part being dented radially, and the adhesive is continuously applied to the first bent part, the notched part and the inner peripheral portion.

20. The rotary device as claimed in claim 16, further comprising at least one of an adhesive sheet and a double-sided adhesive sheet, the adhesive sheet being applied from the rotatable member to a top surface of the cap beyond the notched part, the double-sided adhesive sheet being applied between an end surface of the cap and the bottom.
